(19) United States
(12) Patent Application Publication
(10) Pub. No.: US 2013/0057482 A1
(43) Pub. Date: Mar. 7, 2013

(54) DISPLAY DEVICE

(71) Applicants: KUO-CHAN PENG, PINGZHEN CITY (TW); CHING-FENG HSIEH, TAIPEI CITY (TW)

(72) Inventors: KUO-CHAN PENG, PINGZHEN CITY (TW); CHING-FENG HSIEH, TAIPEI CITY (TW)

(73) Assignees: ASKEY COMPUTER CORP.; ASKEY TECHNOLOGY (JIANGSU) LTD.

(21) Appl. No.: 13/279,565

(22) Filed: Oct. 24, 2011

(30) Foreign Application Priority Data
Sep. 2, 2011 (TW) 100131770

(51) Int. Cl. G06F 3/041

(52) U.S. Cl. 345/173

(57) ABSTRACT

A display device for extending a view of a handheld electronic device includes a body, a displaying unit, a touch control unit, a connecting unit, a fixing unit, and a receiving recess. The fixing unit has an adjusting member for suiting the fixing unit to the size of the handheld electronic device. The handheld electronic device is received by the receiving recess and held by the fixing unit. The display device receives an audio/video signal and sends it to the displaying unit via the connecting unit. A control signal generated from the touch control unit is transmitted by the connecting unit. Hence, regardless of its dimensions, the handheld electronic device can be fixed to the display device, thereby extending the view of the handheld electronic device.

### CROSS-REFERENCE TO RELATED APPLICATION

This non-provisional application claims priority under 35 U.S.C. §119(a) on Patent Application No(s). 100131770 filed in Taiwan, R.O.C. on Sep. 2, 2011, the entire contents of which are hereby incorporated by reference.

### FIELD OF TECHNOLOGY

The present invention relates to display devices, and more particularly, to a display device for use with handheld electronic devices.

### BACKGROUND

Among mainstream consumer electronic products, smartphones and tablet PCs have their respective edges and thus have gained their respective slices of market share. Smartphones differ from tablet PCs in terms of dimensions, specifications, and performance Smartphones are lightweight, thin, compact, and readily portable. Tablet PCs feature a large display screen and thus are conducive to working, entertainment, and surfing the Internet. Consumers choose between smartphones and table PCs according to the need for portability and large display screens.

Due to their susceptibility to limitations of internal space and dependence on available technology, cell phones used to be outperformed by tablet PCs and notebook computers. However, smartphones are becoming more robust and versatile because of recent technological development. To enhance ease of use, it is a trend for smartphones to have ever-increasing dimensions of a screen. The trend is, however, held in check by communication functions and portability. As a result, commercially available smartphones usually have a screen of a dimension less than five inches.

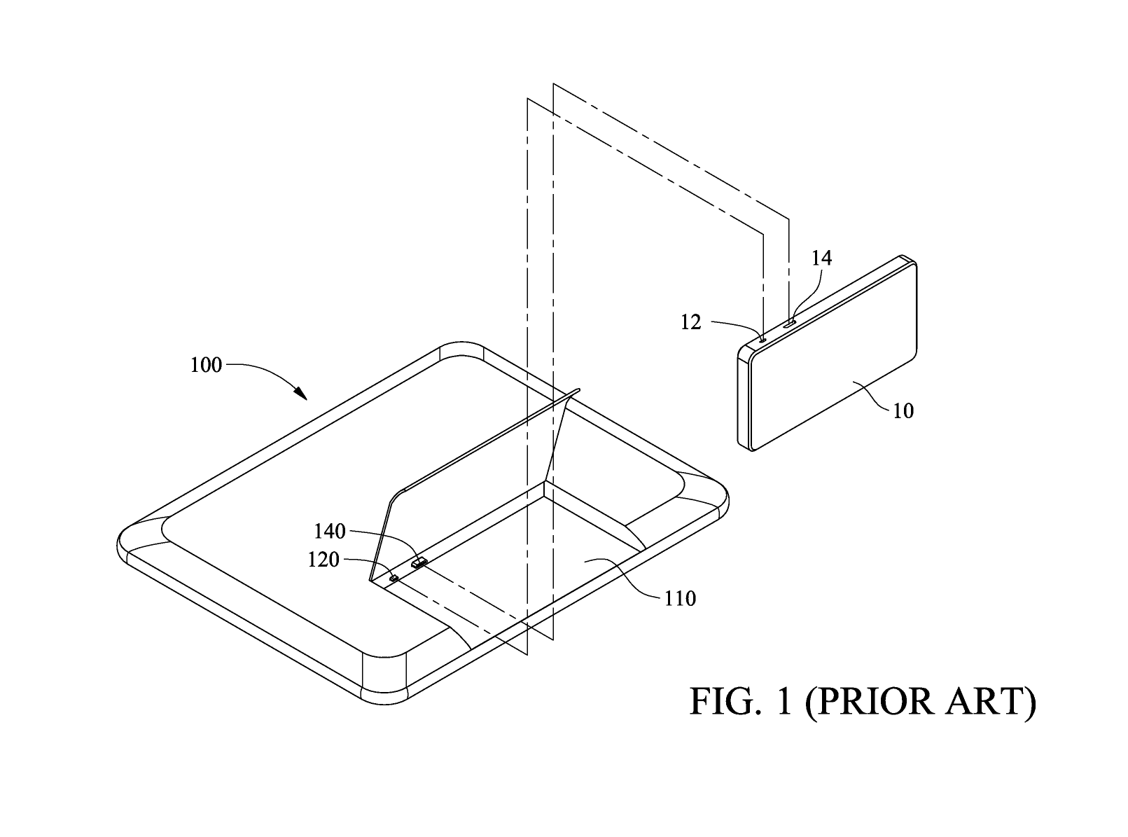

In addition to a large display screen, tablet PCs have an advantage of their similarity with smartphones in terms of functions and performance. This paves the way for the advent of a new product based on integration of tablet PCs and smartphones. Referring to FIG. 1, provided is a touch control monitor 100 capable of receiving a smartphone 10. A receiving chamber 110 is disposed on the rear side of the touch control monitor 100. Transmission jacks 120, 140 for transmitting and receiving signals are disposed at a sidewall of the receiving chamber 110. The transmission jacks 120, 140 correspond in position and category to transmission apertures 12, 14 on the smartphone 10. The transmission interface for the transmission jacks 120, 140 and the transmission apertures 12, 14 is usually a High-Definition Multimedia Interface (HDMI) or a Universal Serial Bus (USB) interface. Hence, the smartphone 10 can be received in the receiving chamber 110 of the touch control monitor 100, and the transmission jacks 120, 140 can be connected to the transmission apertures 12, 14, such that an audio/video signal of the smartphone 10 can be displayed on the touch control monitor 100 by means of a HDMI transmission line to thereby enlarge the view of the smartphone 10 and send a control signal from the touch control monitor 100 to the smartphone 10 by means of a USB transmission line. In doing so, a user is able to use the smartphone 10 independently to meet the strict requirement of portability. Furthermore, it is feasible to combine the smartphone 10 and the touch control monitor 100 in order to bring about a large display screen.

Nonetheless, the touch control monitor 100 still has an unsolved disadvantage, that is, the application of the touch control monitor 100 is restricted to the smartphone 10 of specific model numbers, as opposed to all model numbers and all specifications, nor can the touch control monitor 100 be in use with other handheld electronic devices, because the receiving chamber 110 and the transmission jacks 120, 140 cannot work without conforming with the dimensions of the smartphone 10 and the positions and interface categories of the transmission apertures 12, 14.

### SUMMARY

It is an objective of the present invention to provide a display device applicable to handheld electronic devices of any model numbers and specifications and capable of displaying the view of the handheld electronic devices.

In order to achieve the above and other objectives, the present invention provides a display device for use with a handheld electronic device having an output unit and an input unit. The handheld electronic device generates an audio/video signal. The display device comprises: a body; a fixing unit disposed on a side of the body and comprising an adjusting member adapted to adjust the fixing unit to a size of the handheld electronic device, such that the handheld electronic device is fixed in placed by the fixing unit; a connecting unit electrically connected to the output unit and the input unit for receiving the audio/video signal; a displaying unit disposed on another side of the body and electrically connected to the connecting unit for displaying the audio/video signal; and a touch control unit disposed on the displaying unit and electrically connected to the connecting unit for generating a control signal, wherein the control signal is sent to the input unit via the connecting unit.

Regarding the display device, the display device further comprises a receiving chamber. The receiving chamber is disposed on one side of the body such that the fixing unit is disposed in the receiving chamber. The fixing unit comprises a first clamping member connected to the adjusting member for adjusting the first clamping member to the size of the handheld electronic device, such that the handheld electronic device is flanked by and clamped with a sidewall of the receiving chamber and the first clamping member.

The connecting unit has at least one transmission jack disposed on the first clamping member and adapted to be electrically connected to the output unit by movement-based position adjustment.

Regarding the display device, the fixing unit comprises a first clamping member and a second clamping member which are connected to the adjusting member for adjusting the first clamping member and the second clamping member to the size of the handheld electronic device, such that the handheld electronic device is jointly clamped by the first clamping member, the second clamping member, and two adjacent sidewalls of the receiving chamber. The connecting unit has a transmission jack disposed on at least one of the first clamping member and the second clamping member and adapted to be electrically connected to the output unit by movement-based position adjustment.

Regarding the display device, the fixing unit further comprises a protective pad disposed on the fixing unit.

Regarding the display device, the fixing unit further comprises a button for adjustably controlling the fixing unit in clamping or loosening the handheld electronic device.

Regarding the display device, the connecting unit has at least one transmission jack electrically connected to the output unit and the input unit, respectively.

Regarding the display device, the connecting unit receives the audio/video signal by cable transmission or radio transmission. The connecting unit receives the audio/video signal by at least one of HDMI, VGA, DVI, DisplayPort, USB, Bluetooth, and NFC.

Regarding the display device, the connecting unit transmits the control signal by cable transmission or radio transmission. The connecting unit receives the control signal by at least one of USB, HDMI, Bluetooth, NFC, and Wi-Fi.

Regarding the display device, the display device further comprises a covering body for covering the receiving chamber. A receiving portion is disposed in the receiving chamber.

Hence, the fixing unit of the display device of the present invention is adjusted to different dimensions of the handheld electronic devices, such that the handheld electronic devices of different dimensions can be clamped and fixed in place, thereby extending the view of various handheld electronic devices.

### BRIEF DESCRIPTION

Objectives, features, and advantages of the present invention are hereunder illustrated with specific embodiments in conjunction with the accompanying drawings, in which:

FIG. 1 (PRIOR ART) is a schematic view of a conventional display device for displaying the view of a handheld electronic device;

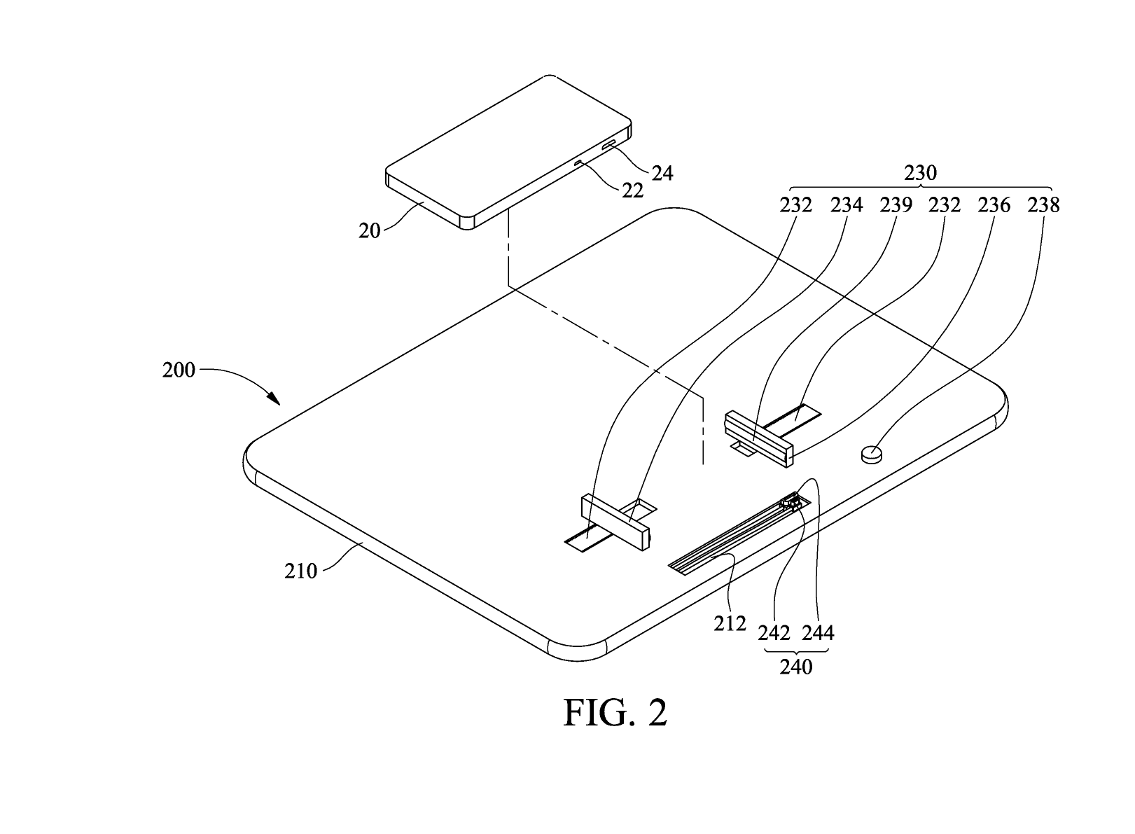

FIG. 2 is a schematic view of a display device according to the first embodiment of the present invention;

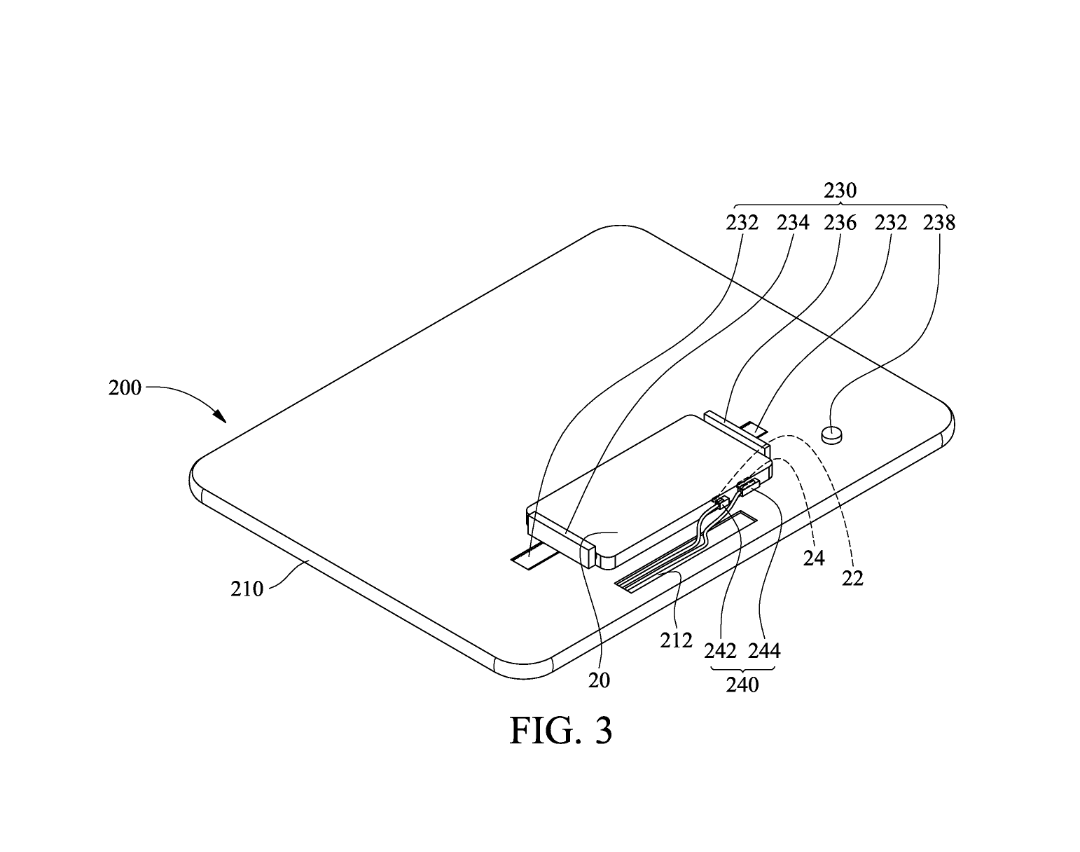

FIG. 3 is a schematic view of the display device having a handheld electronic device fixed thereto according to the first embodiment of the present invention;

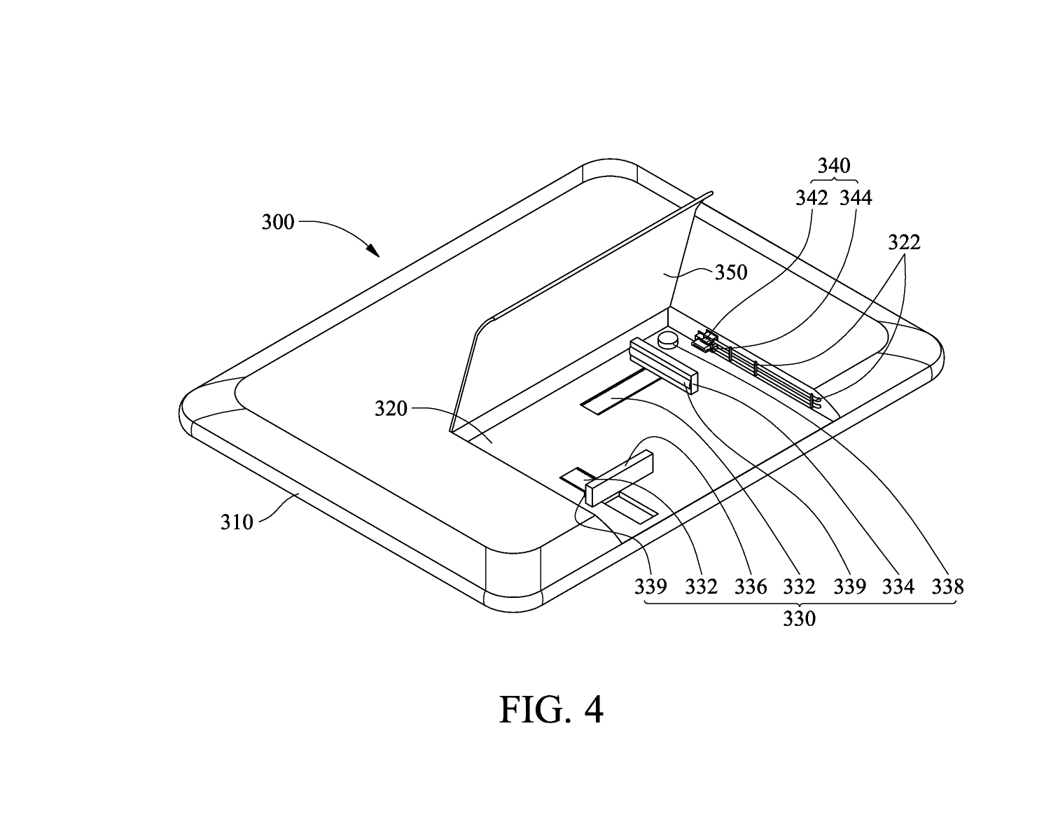

FIG. 4 is a schematic view of a display device according to the second embodiment of the present invention;

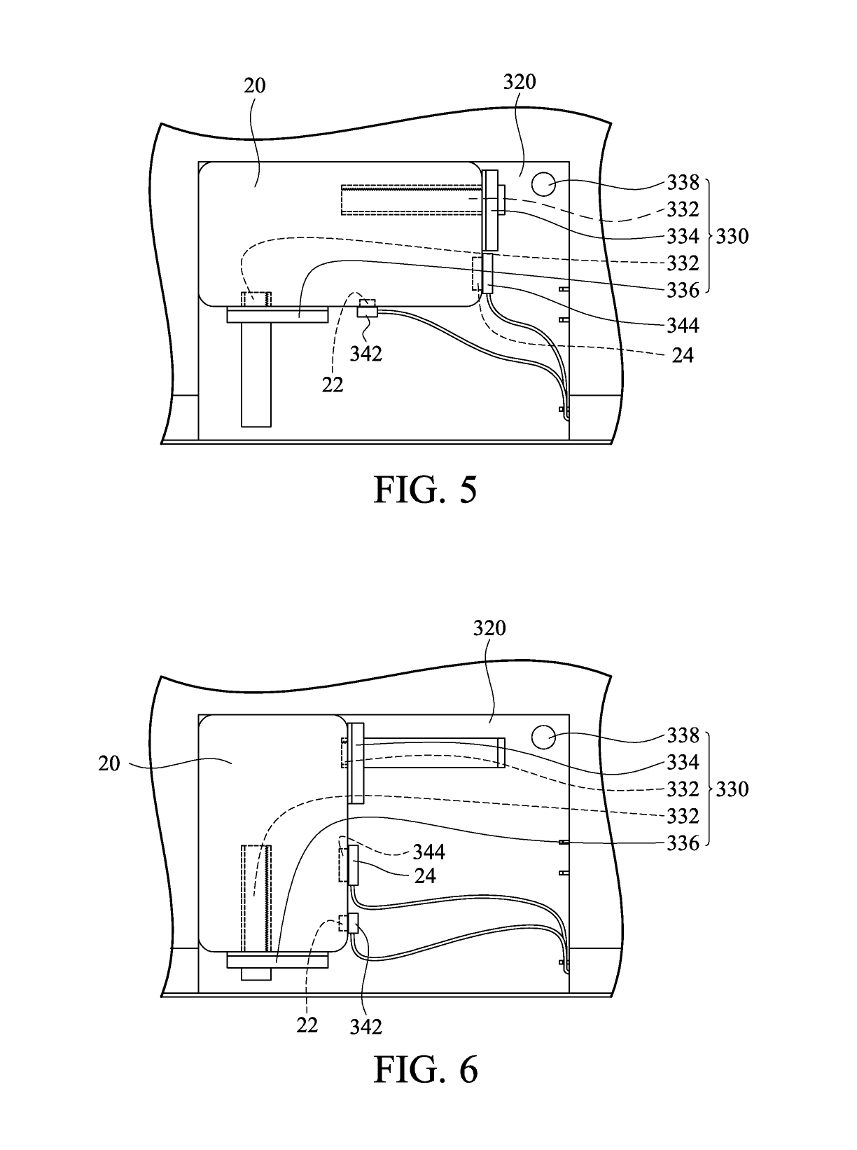

FIG. 5 is a schematic view of the handheld electronic device transversely disposed in the display device according to the second embodiment of the present invention;

FIG. 6 is a schematic view of the handheld electronic device vertically disposed in the display device according to the second embodiment of the present invention;

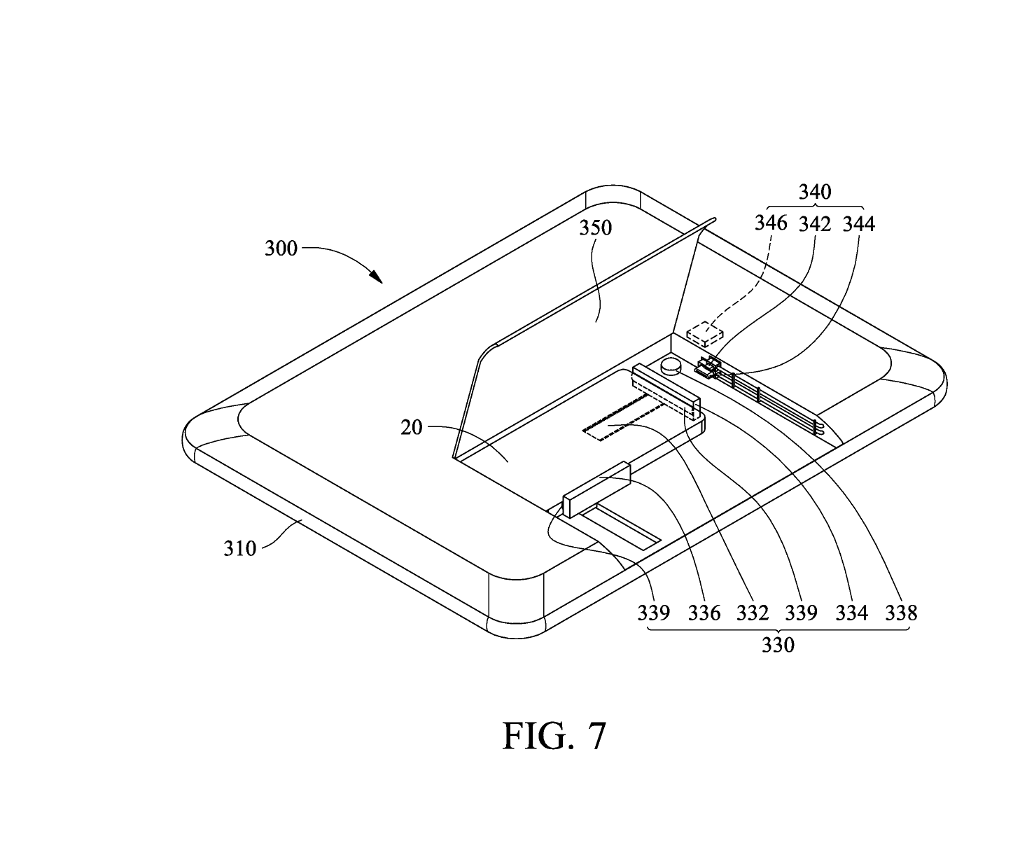

FIG. 7 is a schematic view of radio transmission between the display device and the handheld electronic device according to the second embodiment of the present invention;

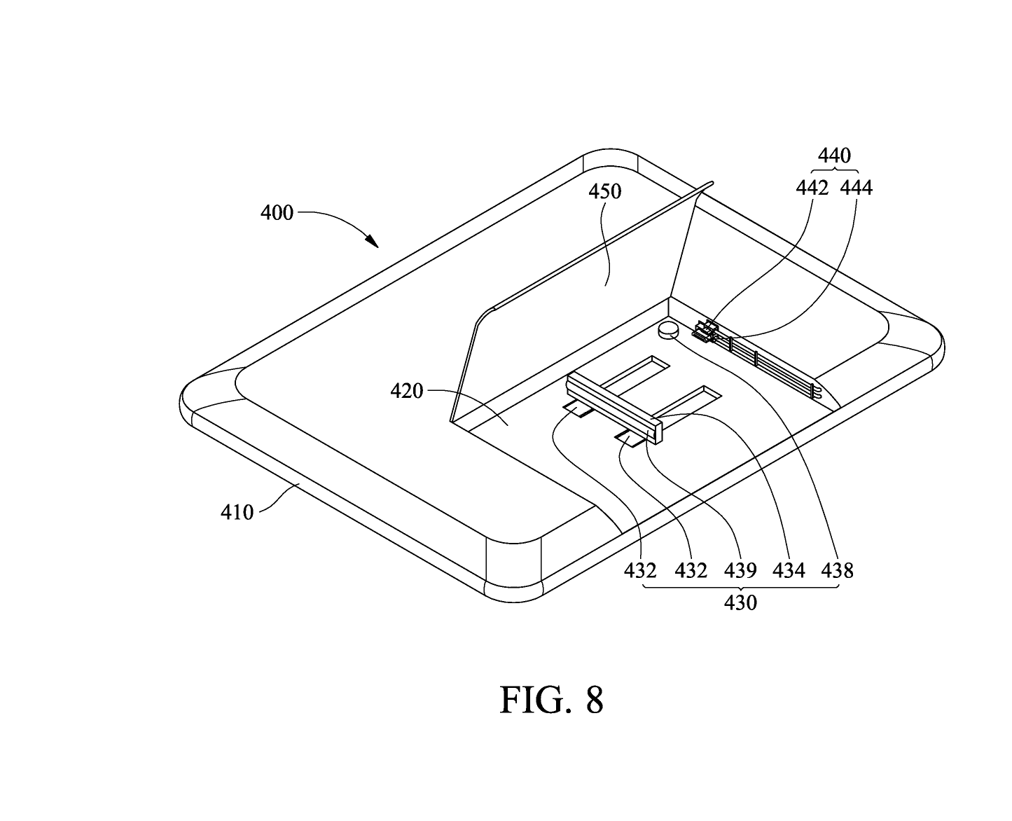

FIG. 8 is a schematic view of a display device according to the third embodiment of the present invention;

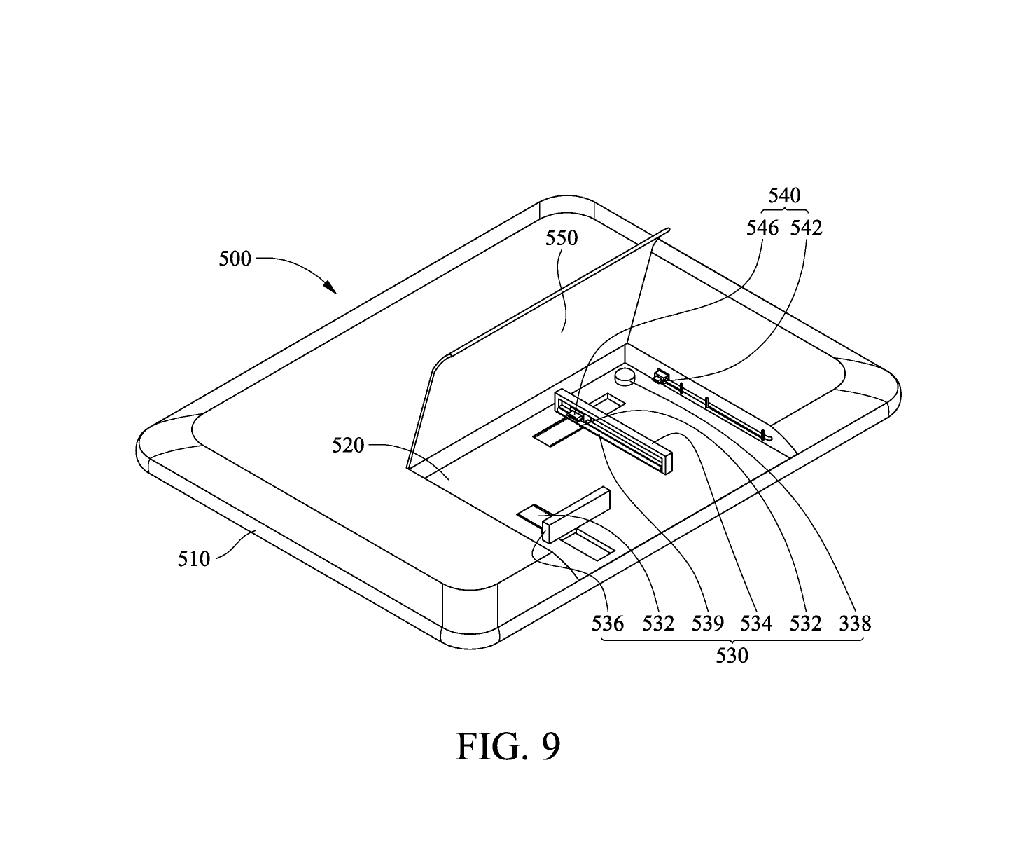

FIG. 9 is a schematic view of a display device according to the fourth embodiment of the present invention; and

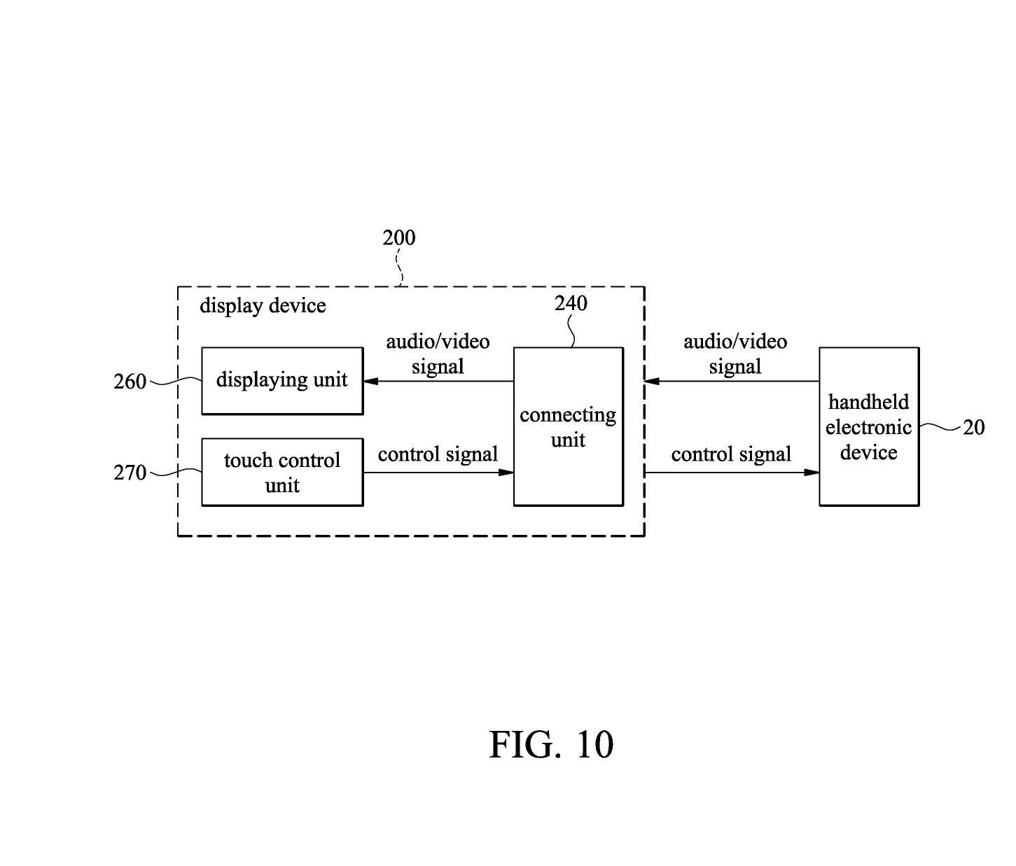

FIG. 10 is a schematic view of transmission of an audio/video signal and a control signal between the display device and the handheld electronic device according to the present invention.

### DETAILED DESCRIPTION

Referring to FIG. 2 and FIG. 3, there are shown schematic views of a display device according to the first embodiment of the present invention. As shown in FIG. 2 and FIG. 3, a display device 200 in the first embodiment of the present invention displays the view of a handheld electronic device 20. The handheld electronic device 20 has an output unit 22 and an input unit 24 for transmitting an audio/video signal, a control signal, and other signals. In this embodiment, the handheld electronic device 20 is exemplified by a smartphone. A transmission aperture of the output unit 22 having an HDMI transmission interface and a transmission aperture of the input unit 24 having a USB transmission interface are disposed on a side surface of the handheld electronic device 20.

Referring to FIG. 2, FIG. 3, and FIG. 10, in the first embodiment, the display device 200 comprises a body 210, a fixing unit 230, a connecting unit 240, a displaying unit 260 (FIG. 10), and a touch control unit 270 (FIG. 10). The fixing unit 230 is disposed on one side of the body 210 and comprises an adjusting member 232. The adjusting member 232 adjusts the fixing unit 230 to the size of the handheld electronic device 20 and thereby fixes the handheld electronic device 20 in place. The connecting unit 240 is electrically connected to the output unit 22 and the input unit 24 of the handheld electronic device 20 for receiving an audio/video signal generated from the output unit 22 of the handheld electronic device 20. The displaying unit 260 is disposed on the other side of the body 210 and electrically connected to the connecting unit 240 for displaying the audio/video signal generated from the output unit 22 of the handheld electronic device 20. The touch control unit 270 is disposed on the displaying unit 260 and electrically connected to the connecting unit 240 for generating a control signal. The control signal is sent to the input unit 24 of the handheld electronic device 20 via the connecting unit 240.

The fixing unit 230 of the display device 200 according to the first embodiment of the present invention comprises the adjusting member 232, a first clamping member 234 and a second clamping member 236. The adjusting member 232 adjusts the positions of the first clamping member 234 and the second clamping member 236 to the size of the handheld electronic device 20, such that the handheld electronic device 20 is flanked by and clamped with the first clamping member 234 and the second clamping member 236, thereby allowing the handheld electronic device 20 to be fixed to one side of the body 210. This embodiment is exemplified by clamping but is not limited thereto, as the handheld electronic device 20 in this embodiment can also be fixed in placed by snap engagement or by any other appropriate means.

The fixing unit 230 further comprises a button 238 disposed on one side of the body 210. A user presses the button 238 to adjustably control the fixing unit 230 in clamping or loosening the handheld electronic device 20. For example, the adjusting member 232 comprises two racks and a gear. The gear is fixed to the body 210. The relative movement of the two racks and the gear brings about the displacement and adjustment of the first clamping member 234 and the second clamping member 236. The button 238 is movably connected to an engaging mechanism of the gear in a manner that the racks and the gear are stationary or movable relative to each other. Once the user presses the button 238, the engaging mechanism will be disengaged from the gear, thereby allowing the racks and the gear to move relative to each other; hence, the first clamping member 234 and the second clamping member 236 which are connected to the racks, respectively, are movable and adjustable to the size of the handheld electronic device 20. Once the first clamping member 234 and the second clamping member 236 abut against the two sides of the handheld electronic device 20, respectively, the user can release the button 238 to allow the engaging mechanism to fix the racks and the gear in place, such that the handheld electronic device 20 is clamped and fixed in place by the fixing unit 230.

Furthermore, a protective pad 239 is disposed on the first clamping member 234 and the second clamping member 236 and adapted to prevent the handheld electronic device 20 from being scraped or scratched and assist the first clamping member 234 and the second clamping member 236 in clamping and securing the handheld electronic device 20.

The connecting unit 240 of the display device 200 in the first embodiment of the present invention is connected to the output unit 22 and the input unit 24 of the handheld electronic device 20 by means of cable transmission. The connecting unit 240 comprises transmission jacks 242, 244 equipped with transmission lines. In this regard, the transmission jack 242 has an HDMI transmission interface, and the transmission jack 244 has a USB transmission interface. The transmission jack 242 is adapted to be electrically connected to the output unit 22 which is disposed on the handheld electronic device 20 and has a corresponding HDMI transmission interface. The transmission jack 244 is adapted to be electrically connected to the input unit 24 which is disposed on the handheld electronic device 20 and has a corresponding USB transmission interface, as shown in FIG. 3. However, this embodiment is not restrictive of the type of a transmission interface between the connecting unit 240 and the output unit 22 and the input unit 24 of the handheld electronic device 20, because the transmission interface may also be VGA (Video Graphics Array), DVI (Digital Visual Interface), or DisplayPort. Furthermore, the user may connect the transmission jacks of the connecting unit 240 to the output unit 22 and the input unit 24 of the handheld electronic device 20 by means of a transmission line without being limited by the aforesaid positions of the transmission jacks on the body 210.

The body 210 further comprises a receiving portion 212. The receiving portion 212 is a recess for receiving the transmission jacks 242, 244 and the transmission lines. This embodiment is not restrictive of the structure of the receiving portion 212, as the structure of the receiving portion 212 can be provided in any form as needed, such as a coiling structure or an engaging hook.

Regarding the display device 200 according to the first embodiment of the present invention, the handheld electronic device 20 is fixed by the fixing unit 230 to the rear side (the side opposite to the displaying unit 260 and the touch control unit 270) of the body 210 of the display device 200. The connecting unit 240 electrically connects the display device 200 to the output unit 22 and the input unit 24 of the handheld electronic device 20, such that the audio/video signal generated from the handheld electronic device 20 is sent to the displaying unit 260 via the output unit 22 and the connecting unit 240 and displayed by the displaying unit 260.

Referring to FIG. 4 through FIG. 6, there are shown schematic views of a display device 300 according to the second embodiment of the present invention. The display device 300 according to the second embodiment of the present invention essentially comprises a body 310, a fixing unit 330, a connecting unit 340, a displaying unit (not shown), and a touch control unit (not shown). In this embodiment, the display device 300 further comprises a receiving chamber 320. The receiving chamber 320 is disposed on one side of the body 310 for receiving the handheld electronic device 20. The fixing unit 330 is disposed in the receiving chamber 320 and has an adjusting member 332. The adjusting member 332 adjusts the fixing unit 330 to the size of the handheld electronic device 20, such that the handheld electronic device 20 is fixed to the receiving chamber 320. The connecting unit 340 is electrically connected to the output unit 22 and the input unit 24 of the handheld electronic device 20 for receiving the audio/video signal from the output unit 22 of the handheld electronic device 20. The displaying unit is disposed on the other side of the body 310 and electrically connected to the connecting unit 340 for displaying the audio/video signal sent out from the handheld electronic device 20. The touch control unit is disposed on the displaying unit and electrically connected to the connecting unit 340 for generating a control signal. The control signal is sent to the input unit 24 of the handheld electronic device 20 via the connecting unit 340.

The fixing unit 330 of the display device 300 according to the second embodiment of the present invention comprises the adjusting member 332, a first clamping member 334, and a second clamping member 336. The first clamping member 334 and the second clamping member 336 correspond in position to and clamp two adjacent sides of the handheld electronic device 20. The adjusting member 332 adjusts the positions of the first clamping member 334 and the second clamping member 336 to the size of the handheld electronic device 20. To be specific, the adjusting member 332 adjusts the distance between the first clamping member 334 and a corresponding one of the sidewalls of the receiving chamber 320 and adjusts the distance between the second clamping member 336 and another corresponding one of the sidewalls of the receiving chamber 320 to the length and the width of the handheld electronic device 20, respectively, such that the handheld electronic device 20 is jointly clamped by the first clamping member 334, the second clamping member 336, and two adjacent sidewalls of the receiving chamber 320.

The connecting unit 340 of the display device 300 according to the second embodiment of the present invention is connected to the output unit 22 and the input unit 24 of the handheld electronic device 20 by means of cable transmission. The connecting unit 340 comprises transmission jacks 342, 344 equipped with transmission lines. In this regard, the transmission jack 342 has an HDMI transmission interface, and the transmission jack 344 has a USB transmission interface. The transmission jack 342 is adapted to be electrically connected to the output unit 22 which has a corresponding HDMI transmission interface. The transmission jack 344 is adapted to be electrically connected to the input unit 24 which has a corresponding USB transmission interface. In addition, as shown in FIG. 5 and FIG. 6, the handheld electronic device 20 is transversely or vertically disposed in the receiving chamber 320 and fixed in place by the fixing unit 330. Hence, the handheld electronic device 20 can be positioned in a manner according to the positions of the output unit 22 and the input unit 24, so as to bring about the following effects: the output unit 22 and the input unit 24 are not hidden by the fixing unit 330; the handheld electronic device 20 is fixed to the receiving chamber 320 by means of the fixing unit 330; and the connecting unit 340 is electrically connected to the output unit 22 and the input unit 24 of the handheld electronic device 20 by means of transmission lines.

In this embodiment, a receiving portion 322 is exemplified by an engaging hook. The transmission lines and the transmission jacks 342, 344 are fixed to the receiving portion 322 on the sidewall of the receiving chamber 320 by means of the engaging hook while the display device of the present invention is not in use. Once the transmission jacks 342, 344 are inserted into and connected to the handheld electronic device 20, a redundant portion of the transmission lines is fixed to the receiving portion 322 on the sidewall of the receiving chamber 320 by means of the engaging hook, such that the transmission lines are tucked and secured in place neatly.

The display device 300 further comprises a covering body 350 for covering the receiving chamber 320 to protect the handheld electronic device 20 received therein. The appended drawings are not restrictive of the covering body 350, and thus the covering body 350 is of a pop-up style, a sliding style, or a snap engagement style.

Referring to FIG. 7, regarding the display device 300 in the second embodiment of the present invention, the means of signal transmission between the connecting unit 340 and the handheld electronic device 20 is not restricted to cable transmission; instead, it is also feasible to receive the audio/video signal or transmit the control signal by means of radio transmission. For example, the connecting unit 340 of the display device 300 comprises a radio transmission interface 346 of Bluetooth or NFC (Near Field Communication), such that a chip on a circuit board disposed in the body receives the audio/video signal from the handheld electronic device 20 or sends the control signal from the display device 300 to the handheld electronic device 20, thereby dispensing with cable transmission between a transmission line and a transmission jack. Hence, the signal transmission between the display device 300 and the handheld electronic device 20 is effected mostly by radio transmission, such that the handheld electronic device 20 capable of radio transmission can be directly received in the display device 300 for transmitting the audio/video signal of the handheld electronic device 20 and displaying the view thereof and thereby enabling a user to operate the display device 300 by touch control. In addition, it is also feasible that the transmission jacks 342, 344 equipped with transmission lines function as standby transmission jacks or serve other data transmission purposes. Accordingly, the display device 300 is universally applicable to handheld electronic devices capable of cable and radio transmission.

Referring to FIG. 8, there is shown a schematic view of a display device 400 according to the third embodiment of the present invention. Regarding the display device 400 according to the third embodiment of the present invention, a receiving chamber 420 is disposed on one side of the body 410. A fixing unit 430 and a connecting unit 440 are disposed in the receiving chamber 420. The fixing unit 430 comprises an adjusting member 432 and a first clamping member 434. The first clamping member 434 is connected to the adjusting member 432 to enable the adjusting member 432 to adjust the position of the first clamping member 434 to the width or the length of the handheld electronic device 20, such that two opposite sides of the handheld electronic device 20 are clamped by the first clamping member 434 and a sidewall of the receiving chamber 420, respectively, thereby allowing the handheld electronic device 20 to be fixed to the receiving chamber 420. Likewise, the exemplary structures of a covering body 450, the adjusting member 432, a button 438, and a protective pad 439 of the fixing unit 430, transmission jacks 442, 444 of the connecting unit 440, and other features of this embodiment are similar to those of the aforesaid embodiments and thus are not described in detail herein for the sake of brevity.

Referring to FIG. 9, there is shown a schematic view of a display device 500 according to the fourth embodiment of the present invention. Regarding the display device 500 according to the fourth embodiment of the present invention, a receiving chamber 520 is disposed on one side of a body 510. A fixing unit 530 and a connecting unit 540 are disposed in the receiving chamber 520. The connecting unit 540 comprises a transmission jack 546. The transmission jack 546 is movably disposed on a first clamping member 534, such that the transmission jack 546 is connected to the output unit 22 of the handheld electronic device 20 as soon as the handheld electronic device 20 is clamped by the first clamping member 534. Hence, not only is the first clamping member 534 of the fixing unit 530 adjusted to clamp the handheld electronic device 20, but the transmission jack 546 on the first clamping member 534 is directly inserted into the output unit 22 of the handheld electronic device 20. The transmission jack 546 is movably disposed on the first clamping member 534. For example, the transmission jack 546 is disposed on a slidable block, a sliding groove corresponding in position to the slidable block is disposed on the first clamping member 534, such that the position of the transmission jack 546 relative to the first clamping member 534 can be adjusted according to the position of the output unit 22 of the handheld electronic device 20, because the transmission jack 546 is electrically connected to a displaying unit via a transmission line. Likewise, the transmission jack 546 can also be disposed on a second clamping member 536 as opposed to what is shown in the drawings. Moreover, the connecting unit 540 can further comprise a standby transmission jack 542 for use in other data transmission and for functioning as a cable transmission interface, such as a USB interface. Likewise, the exemplary structures of a covering body 550, an adjusting member 532, a button 538, and a protective pad 539, and other features of this embodiment are similar to those of the aforesaid embodiments and thus are not described in detail herein for the sake of brevity.

Referring to FIG. 10, there is shown a schematic view of transmission of an audio/video signal and a control signal between the display device and the handheld electronic device 20 according to the present invention, wherein the display device is exemplified by the display device 200 of the first embodiment. The audio/video signal is sent from the handheld electronic device 20 to the connecting unit 240 of the display device 200 and then from the connecting unit 240 to a displaying unit 260, such that the audio/video signal is displayed on the displaying unit 260. Once the user starts to operate the touch control unit 270 in a touch-control manner, the touch control unit 270 will generate a control signal and send the control signal to the connecting unit 240. Then, the connecting unit 240 forwards the control signal to the input unit 24 of the handheld electronic device 20. After receiving the control signal, the handheld electronic device 20 operates accordingly. Transmission of the audio/video signal and the control signal between the display device 200 and the handheld electronic device 20 is effectuated by means of cable transmission or radio transmission. The connecting unit 240 comprises a transmission interface of HDMI, VGA, DVI, DisplayPort, USB, Bluetooth, or NFC for receiving the audio/video signal from the handheld electronic device 20. Or, alternatively, the connecting unit 240 comprises a transmission interface of USB, HDMI, Bluetooth, NFC, or Wi-Fi for sending the control signal to the handheld electronic device 20. Furthermore, the second through fourth embodiments are the same as the first embodiment in terms of the transmission of the audio/video signal and the control signal between the handheld electronic device 20 and the display devices 300, 400, 500.

Hence, in the first embodiment through the fourth embodiment of the present invention, the fixing unit of the display device is adjusted to different dimensions of the handheld electronic devices, such that the handheld electronic devices of different dimensions can be clamped and fixed in place, thereby extending the view of various handheld electronic devices.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A display device for use with a handheld electronic device having an output unit and an input unit, the handheld electronic device generating an audio/video signal, the output unit outputting the audio/video signal, the display device comprising:
a body;
a fixing unit disposed on a side of the body and comprising an adjusting member adapted to adjust the fixing unit to a size of the handheld electronic device, such that the handheld electronic device is fixed in placed by the fixing unit;
a connecting unit electrically connected to the output unit and the input unit for receiving the audio/video signal;
a displaying unit disposed on another side of the body and electrically connected to the connecting unit for displaying the audio/video signal; and
a touch control unit disposed on the displaying unit and electrically connected to the connecting unit for generating a control signal, wherein the control signal is sent to the input unit via the connecting unit.

2. The display device of claim 1, further comprising a receiving chamber disposed on a side of the body such that the fixing unit is disposed in the receiving chamber.

3. The display device of claim 2, wherein the fixing unit comprises a first clamping member connected to the adjusting member for adjusting the first clamping member to the size of the handheld electronic device, such that the handheld electronic device is flanked by and clamped with a sidewall of the receiving chamber and the first clamping member.

4. The display device of claim 3, wherein the connecting unit has at least a transmission jack disposed on the first clamping member and adapted to be electrically connected to the output unit by movement-based position adjustment.

5. The display device of claim 2, further comprising a covering body disposed on a side of the body for covering the receiving chamber.

6. The display device of claim 2, wherein a receiving portion is disposed in the receiving chamber.

7. The display device of claim 1, wherein the fixing unit comprises a first clamping member and a second clamping member which are connected to the adjusting member for adjusting the first clamping member and the second clamping member to the size of the handheld electronic device, such that the handheld electronic device is jointly clamped by the first clamping member, the second clamping member, and two adjacent sidewalls of the receiving chamber.

8. The display device of claim 7, wherein the connecting unit has a transmission jack disposed on at least one of the first clamping member and the second clamping member and adapted to be electrically connected to the output unit by movement-based position adjustment.

9. The display device of claim 1, wherein the fixing unit further comprises a protective pad disposed on the fixing unit.

10. The display device of claim 1, wherein the fixing unit further comprises a button for adjustably controlling the fixing unit in clamping or loosening the handheld electronic device.

11. The display device of claim 1, wherein the connecting unit has at least a transmission jack electrically connected to the output unit and the input unit, respectively.

12. The display device of claim 1, wherein the connecting unit receives the audio/video signal by one of cable transmission and radio transmission.

13. The display device of claim 12, wherein the connecting unit receives the audio/video signal by at least one of HDMI, VGA, DVI, DisplayPort, USB, Bluetooth, and NFC.

14. The display device of claim 1, wherein the connecting unit transmits the control signal by one of cable transmission and radio transmission.

15. The display device of claim 14, wherein the connecting unit transmits the control signal by at least one of USB, HDMI, Bluetooth, NFC, and Wi-Fi.
